(19) United States
(12) Patent Application Publication
(10) Pub. No.: US 2005/0214483 A1
(43) Pub. Date: Sep. 29, 2005

(54) Method for forming multilayered coating film

(76) Inventors: Tsukasa Fujieda, Yokohama-shi (JP); Miho Sakai, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/086,387

(22) Filed: Mar. 23, 2005

(30) Foreign Application Priority Data
Mar. 25, 2004 (JP) 2004-88174

(51) Int. Cl. B05D 1/12; B32B 27/20

(52) U.S. Cl. 428/31; 427/402; 427/180; 428/411.1

(57) ABSTRACT

This invention relates to a method for forming multilayered coating film, which comprises applying onto a substrate base paint (A) containing effect pigment, applying onto the resulting base coat, clear paint (B), thereafter hardening the coating film by heating, further applying onto the resulting clear coat, color clear paint (C) containing color pigment and/or dye, and applying onto the resulting color clear coat, top clear paint (D).

### TECHNICAL FIELD

This invention relates a method for forming multilayered coating film of high chroma and deepness feel.

### BACKGROUND ART

It is already known to use as an intermediate layer of a multilayered coating film a color clear coating film, for the purpose of obtaining a high chroma, metallic multilayered coating film excelling in deepness feel. For example, JP2001-314807A discloses a method for forming multilayered coating film of excellent color appearance, which comprises the steps of applying onto a substrate surface a first paint containing a color material and/or effect pigment, to form a first coating film; applying onto the first containing film which is not yet baking-hardened a second paint containing 0.01-1 weight % to the solid resin component therein of a color material, to form a second coating film; and further applying thereonto, without baking-hardening the second coating film, a clear paint to form a clear coating film. However, this method is subject to such problems as floating or uneven coloring is apt to be caused by variation in film thickness and occasionally frames are formed particularly at edge portions.

### DISCLOSURE OF THE INVENTION

The main object of the present invention is to provide a method for forming high chroma multilayered coating film excelling in deepness feel, without causing such problems as described above.

According to the present invention, a method for forming multilayered coating film is provided, which method is characterized by comprising applying a base paint (A) containing effect pigment onto a substrate, applying onto so obtained base coat a clear paint (B), then hardening the coating film by heating, further applying a color clear paint (C) containing color pigment and/or dye onto the resulting clear coat, and applying a top clear paint (D) onto the resulting color clear coat.

According to the present method, high chroma multilayered coating film excelling in deepness feel can be obtained, without causing floating such as formation of frames at edge portions.

In coating outer panels of car bodies, mostly a coating system which is referred to as “two-coat one-bake” (2C1B) is adopted, which comprises applying a base paint onto an intermediate coating film, applying a clear paint onto the resulting unhardened coating films and then heating and hardening these two paints simultaneously, and coating lines in car-making factories generally have the layout suitable for 2C1B steps.

On the other hand, more excellent color and appearance is demanded for outer panels of car bodies, which demand is often met by increasing the number times of coating application. More specifically, for example, a coating system which is referred to as “three-coat one bake” (3C1B) is adopted, which comprises applying a base paint on an intermediate base coating film, applying a color clear paint onto the unhardened base coating film, further applying a clear paint onto the unhardened coating films, and heating and hardening these three paints simultaneously. In such a case, generally it becomes necessary to change the layout of coating lines, such as providing facilities exclusively for the color clear paint application. Whereas, according to the method of the present invention, high chroma multilayered coating film excelling in deepness feel can be readily obtained by 4C2B steps in which 2C1B steps are conducted twice without providing facilities exclusively for color clear paint application but using the coating line layout suitable for 2C1B steps as it is, by using same resin component as at least a part of vehicles for said base paint (A) and color clear paint (C). That is, the method comprises applying a base paint (A) and a clear paint(B) using said coating line layout, heat hardening these two paints; and further applying a color clear paint (C) and a top clear paint (D), and heat-hardening these two paints, using the same coating line once again.

Hereinafter the method of the present invention is explained in further details.

Substrate

Substrate materials to which the method of this invention is applicable are subject to no particular limitation, examples of suitable substrates including members made of metals such as iron, zinc, aluminium and the like; members made of alloys of these metals; members plated or vapor-deposited with these metals; and members made of glass, plastic, or of foams of various materials. In particular, steel materials to construct car bodies are suitable. These members can be suitably given degreasing treatment, surface treatment or the like where necessary. The members on which undercoating film and/or intermediate coating film is/are formed may be used as substrates, which practice is generally preferred.

Undercoating film is applied to such a member surface for the purpose of hiding the latter's surface or imparting to the member anticorrosive and antirusting properties or the like. Said undercoating film can be formed by applying undercoat paint and hardening the same. The undercoat paint is subject to no particular limitation and those known per se, e.g., electrodeposition paint, solvent type primer or the like can be used.

Said intermediate coating film is applied for the purpose of hiding the ground surface such as of the member or of said undercoating film, for improving adhesion between the ground surface with top coating film, or imparting antichipping property to the coating film, which can be formed by applying an intermediate paint onto the ground surface such as of the member or the undercoating film and hardening the same. The intermediate paint is subject to no particular limitation but any of those known per se can be used. For example, organic solvent-based or water-based intermediate paint containing thermosetting resin composition and color pigment can be conveniently used.

In the method of the present invention, where a member on which an undercoating film and/or intermediate coating film is/are formed is used as the substrate, said undercoating film and/or intermediate coating film may be heated and hardened in advance of applying a paint of the next step, but in occasions said paint of the next step can be applied while the undercoating and/or intermediate coating film(s) are still in unhardened condition.

Base Paint (A)

According to the method of the present invention, first a base paint (A) is applied onto a substrate as described above. The base paint (A) is to impart brilliance to the multilayered coating film to be formed, which determines the hue of said multilayered coating film, in particular, the hue at shade portions, and contains effect pigment as an essential compact.

As said effect pigment, for example, flaky metallic pigment formed of such ingredients as, for example, aluminium, copper, nickel alloy, stainless steel or the like, flaky metallic pigment whose surface is covered with metal oxide or flaky metallic pigment onto whose surface color pigment is chemically adsorbed; flaky aluminium pigment on whose surface an aluminium oxide layer is formed through a reductive oxidation induced in situ; platy aluminium-iron oxide solid solution pigment; glass flake pigment, glass flake pigment with metal oxide-covered surface; and glass flake pigment onto whose surface color pigment is chemically adsorbed; iridescent mica pigment with titanium dioxide-covered surface, reduced mica pigment formed by reducing iridescent mica pigment and colored mica pigment onto whose surface color pigment is chemically adsorbed, or that with iron oxide-covered surface; graphite pigment with titanium dioxide-covered surface; silica flake or alumina flake pigment with titanium dioxide-covered surface; platy iron oxide pigment; hologram pigment; synthetic mica pigment; cholesteric liquid crystal polymer pigment having spiral structure; bismuth oxychroride pigment ; and the like can be named. These pigments can be used either singly or in combination of two or more. Of these, flaky metallic pigment, flaky metallic pigment with metal oxide-covered surface, flaky metallic pigment onto whose surface color pigment is chemically adsorbed, and colored mica pigment with metal oxide-covered surface are preferred. In particular, aluminium flake pigment which is one of flaky metallic pigments is preferred, while useful effect pigments are not limited to the foregoing but various effect pigments can be suitably used according to the desired effect of brilliance.

The amount of said effect pigment to be blended is variable depending on the intensity of brilliance desired for the formed multilayered coating film. Whereas, generally it can be within a range of 1-50 parts by weight, preferably 1-40 parts by weight, inter alia, 1-30 parts by weight, per 100 parts by weight of the resin component as the vehicle in the base paint (A).

Said base paint (A) used in the method of the invention may also contain color pigment. An said color pigment, those heretofore known for their use in ink and paint can be used either singly or in combination of two or more, examples of which including metal oxide pigment such as of titanium oxide, iron oxide and the like; mixed metal oxide pigment such as Titanium Yellow; carbon black; and organic pigment such as azo pigment, quinacridone pigment, diketopyrrolopyrrole pigment, perylene pigment, perinone pigment, benzimidazolone pigment, isoindoline pigment, isoindolinone pigment, metal chelate azo pigment, phthalocyanine pigment, indanthrone pigment, dioxane pigment and indigo pigment.

The amount of such color pigment to be blended is not particularly limited, but generally from the standpoint of staining power and finished appearance of the formed coating film, it can be not more than 50 parts by weight, preferably within a range of 0.5-40 parts by weight, inter alia, 1-30 parts by weight, per 100 parts by weight of the resin component as the vehicle in the base paint (A).

The base paint (A) can contain a resin component as the vehicle, besides said effect pigment and color pigment. As the resin component, use of thermosetting resin compositions is preferred. More specifically, for example, thermosetting resin compositions comprising main resin such as acrylic resin, polyester resin, alkyd resin, urethane resin and the like, which have crosslinkable functional groups such as hydroxyl group; and crosslinking agent such as melamine resin, urea resin, polyisocyanate compound (including blocked polyisocyanate compound) and the like, can be named. They can be used in the form as dissolved or dispersed in a solvent such as organic solvent and/or water. The ratio between said main resin and crosslinking agent in said resin compositions is not particularly limited, while in general terms the crosslinking agent can be used within a range of 10-100 parts by weight, preferably 20-80 parts by weight, inter alia, 30-60 parts by weight, per 100 parts by weight of solid component of the main resin.

Such base paint (A) may also be suitably blended with, as necessity demands, solvent such as water or organic solvent; various additives for paint such as rheology controlling agent, pigment dispersant, antisettling agent, hardening catalyst, defoaming agent, antioxidant, UV absorber and the like; extender and the like.

Base paint (A) can be formulated by mixing and dispersing the above-described components.

Base paint (A) can be applied onto a substrate by such means as electrostatic spray application, air spray, airless spray and the like, to a thickness within a range of 0.5-30 μm, in terms of its hardened coating film. From the viewpoint of surface smoothness of the coating film, particularly the range of 5-25 μm is preferred. When spray-applied, it is normally preferred that the solid content of the base paint (A) should be adjusted in advance to 15-50% by weight, more favorably to 20-40% by weight, and viscosity of the paint at 20° C., to 11-15 seconds/Ford cup #4. The coating film of the base paint (A) (base coat) per se can normally be hardened by crosslinking at temperatures ranging from about 70 to about 150° C.

According to the method of the invention, clear paint (B) can be applied after application and hardening of said base paint (A). It is also permissible to apply said clear paint (B) onto yet unhardened coating film of the paint (A), without heat-hardening the applied base paint (A).

Clear Paint (B)

According to the method of the present invention, onto the base coat as formed in the above-described manner, a cleat paint (B) is applied. As said clear paint (B), a liquid or powder paint formulation containing a resin component and further, where necessary, various additives for paint and solvent such as water or organic solvent, and forming a colorless or colored, transparent coating film can be used. The method of the present invention adopts a coating film structure that the coating film obtained by applying a later-described color clear paint (C) (color clear coat) is held between the coating film obtained by applying said clear paint (B) (clear coat) and a transparent coating film formed by applying a later-described top clear paint (D) (top clear coat), whereby forming a multilayered coating film excelling in deepness feel.

Said clear paint (B) to be used in the method of the present invention is not subject to particular limitations but those known per se can be used. For example, liquid or powder paint compositions comprising a main resin and crosslinking agent can be used. As such main resin, for example, acrylic resin, polyester resin, alkyd resin, fluorocarbon resin, urethane resin, silicone-containing resin and the like which contain crosslinkable functional groups such as hydroxyl, carboxyl, silanol or epoxy groups can be named. As said crosslinking agent, compounds or resins having functional groups reactable with said functional groups in the main resin, for example, melamine resin, urea resin, polyisocyanate compound, blocked polyisocyanate compound, epoxy compound or resin, carboxyl-containing compound or resin, acid anhydride, alkoxysilyl-containing compound or resin and the like can be named. The ratio between the main resin and the crosslinking agent in said resin component is not particularly limited, while generally the crosslinking agent can be used within a range of 10-100 parts by weight, preferably 20-80 parts by weight, inter alia, 30-60 parts by weight, per 100 parts by weight of solid content of the main resin.

Also where necessary, such clear paint (B) can suitably contain solvent such as water or organic solvent, and additives for paint such as hardening catalyst, defoaming agent, UV absorber, rheology-controlling agent, antisettling agent and the like.

In clear paint(B), color pigment may suitably be blended, within a range not impairing transparency of the coating film. As such color pigment, those per se known for use in ink or paint can be blended either singly or in combination of two or more. The blending amount varies depending on the kind of used color pigment, while it can be normally used in an amount not more than 30 parts by weight, preferably within a range of 0.05-20 parts by weight, inter alia, 0.1-10 parts by weight, per 100 parts by weight of the resin component as vehicle in the clear paint (B).

The clear paint (B) can be formulated by mixing and dispersing the above-described components.

The clear paint (B) can be applied onto the base coat by such means as electrostatic application, air spray, airless spray and the like. From the viewpoint of surface smoothness of the coating film, the film thickness can generally range 15-50 μm, in particular, 25-40 μm, in terms of hardened film. Where the clear paint (B) is liquid and applied by spraying, it is normally preferred to adjust its solid content to 30-60% by weight, preferably 40-50% by weight and the viscosity, to 18-25 seconds/Ford cup #4, in advance of its application. The coating film of the clear paint (B) (clear coat) per se can be hardened normally at about 70-about 150° C.

According to the method of the present invention, color clear paint (C) is further applied onto the clear coat obtained by applying said clear paint (B), to form a color clear coating film. Said color clear paint (C) can be applied onto unhardened or hardened coated surface of said clear paint (B).

Color Clear Paint (C)

According to the method of the present invention, color clear paint (C) is applied onto the clear coat formed as described above. Said color clear paint (C) is used for imparting transparent feel and deepness feel to the intended multilayered coating film, without impairing brilliance of said multilayered coating film, and comprises color pigment and/ or dye as the essential component.

As the color pigment which can be contained in the color clear pigment (C), those pigment per se known for use in ink or paint can be used either singly or in combination of two or more, examples of which including metal oxide pigment such as of titanium oxide, iron oxide and the like; mixed metal oxide pigment such as Titanium Yellow; carbon black; and organic pigment such as azo pigment, quinacridon pigment, diketopyrrolopyrrole pigment, perylene pigment, perinone pigment, benzimidazolone pigment, isoindoline pigment, isoindolinone pigment, metal chelate azo pigment, phthalocyanine pigment, indanthrone pigment, dioxane pigment and indigo pigment.

Where the base paint (A) contains color pigment, it is desirable that at least one kind of the color pigment blended in the color clear paint (C) should have a chemical structure identical with that of the color pigment contained in the base paint (A).

While said color pigment or pigments are blended, from the viewpoint of finished appearance and transparency of the resulting coating film, the blended amount can normally be within a range of 0.01- 20 parts by weight, preferably 0.05-15 parts by weight, inter alia, 0.1-10 parts by weight, per 100 parts by weight of the resin component as the vehicle in the color clear paint (C).

Also as the dye which can be contained in the color clear paint (C), those dyes known per se for use in ink, paint or plastic can be used either singly or in combination of two or more. As examples of such dyes, azo dyes, anthraquinone dyes, copper phthalocyanine dyes, metal complex dyes and the like can be named.

Where such dye(s) are blended, the blended amount can normally be within a range of 0.01-10 parts by weight, preferably 0.01-7.5 parts by weight, inter alia, 0.01-5 parts by weight, per 100 parts by weight of the resin component as the vehicle in the color clear paint (C), from the viewpoint of hue and transparent feel of the resulting coating film.

The color clear paint (C) can contain effect pigment, besides said color pigment and/or dye. Said effect pigment is not particularly limited, but those similar to the effect paints named as to the base paint (A) can be used according to the desired brilliance.

Where such effect pigment is used, its blended amount is normally not more than 20 parts by weight, preferably within a range of 0.05-15 parts by weight, inter alia, 0.1-10 parts by weight, per 100 parts by weight of the resin component as the vehicle in the color clear paint(C), from the viewpoint of transparency and brilliance of the resulting coating film.

Besides said color pigment and/or dye and optionally blended effect pigment, the color clear paint (C) can contain as the vehicle a resin component composed of a main resin and crosslinking agent. As the main resin, for example, acrylic resin, polyester resin, alkyd resin, fluorocarbon resin, urethane resin, silicone-containing resin and the like which contain crosslinkable functional groups such as hydroxyl, carboxyl, silanol or epoxy groups can be named. As said crosslinking agent, compounds or resins having functional groups reactable with said functional groups in the main resin, for example, melamine resin, urea resin, polyisocyanate compound, blocked polyisocyanate compound, epoxy compound or resin, carboxyl-containing compound or resin, acid anhydride, alkoxysilyl-containing compound or resin and the like can be named. The ratio between the main resin and the crosslinking agent in said resin component is not particularly limited, while generally the crosslinking agent can be used within a range of 10-100 parts by weight, preferably 20-80 parts by weight, inter alia, 30-60 parts by weight, per 100 parts by weight of solid content of the main resin.

Also where necessary, such color clear paint (C) can suitably contain solvent such as water or organic solvent, and additives for paint such as hardening catalyst, defoaming agent, UV absorber, rheology-controlling agent, antisettling agent and the like.

It is desirable to use in said color clear paint (C), the same resin component serving as the vehicle in the base paint (A) at least as a part of its resin component serving as the vehicle, from the viewpoint of favorable appearance and anti-flooding property of the resulting coating film. This makes it possible to select the best combination of said resin component and color pigment to be blended in the color clear paint (C), from combinations of various resin components and color pigments which were used in base paint (A) and found to show good achievements. In consequence, occurrence of framing phenomenon, which is caused by irregular distribution of color pigment in the occasion of forming a coating film, can be prevented. “Framing phenomenon” said herein refers to a phenomenon such that color pigment and/or dye which is present in uniformly dispersed state in a paint formulation comes to be non-uniformly distributed in the coating film during the heat-hardening procedure after the paint application, resulting in the color at the edge portions of the coated surface becoming darker than that at the inner area, appearing like a frame. Generally speaking, this framing phenomenon often occurs when dispersing stability of color pigment in paint formulation is insufficient. For example, when a resin component for top clear paint having weather resistance is used as the resin component for color clear paint and color pigment is dispersed in said resin component, framing phenomenon may occur because resin component for top clear paint is generally not designed with considerations for dispersing stability of color pigment therein. On the other hand, when at least a part of the resin component serving as the vehicle of color clear paint (C) is the same to the resin component serving as the vehicle of base paint (A), occurrence of framing phenomenon can be inhibited because the resin component for the base paint, which excels in dispersing stability, is used as at least a part of the vehicle of the color clear paint (C).

Furthermore, in coating outer panels of car bodies, frequently a coating system which is referred to as two-coat one-bake (2C1B) is used, in which base paint is applied onto intermediate coating film, and onto the unhardened coated surface a clear paint is applied, followed by simultaneous hardening of these two paints by heating, and coating lines at car-making factories generally have the layout adopted to work 2C1B steps. On the other hand, higher decorative effect for outer panels of car bodies is in demand, which is often dealt with by increasing the number times of paint application. For example, a system comprising applying a base paint onto an intermediate coating film, applying onto the unhardened coated surface a color clear paint, further applying a clear paint onto the unhardened coated surface, and then simultaneously hardening these three paints by heating is adopted, which system being referred to as three-coat one-bake (3C1B) system. In that case, alteration in coating line layout may become necessary. Whereas, when at least a part of the resin component used as the vehicle for the color clear paint (C) is identical with that used in the base paint (A) according to the above-described embodiment of the method of the present invention, multilayered coating films having high saturation and excelling in deepness feel can be obtained without a need to provide facilities exclusively for the color clear paint (C) application, using the coating line layout designed for working 2C1B system. That is, after applying base paint (A) and then clear paint (B) and hardening these paints by heating, the same coating line is used once again to further apply color clear paint (C) and then top clear paint (D) and harden these two paints by heating, to effect 4C2B system in which 2C1B system is repeated twice.

According to the present invention, it is desirable that the difference (Δh) in hue angle h in L*C*h colorimetric system between the coating film obtained by applying said base paint (A) (base coat) and the coating film obtained by applying said color clear paint (C) (color clear coat) is not more than 500, preferably not more than 40°, inter alia, not more than 300. Here “hue angle h” can be determined through colorimetry, with SM Color Computer™ (a colorimeter manufactured by Suga Tester Co.), of dried and hardened coating films formed on a smooth surface of art paper by applying each of base paint (A) and color clear paint (C) to a thickness of 30 μm in terms of hardened film and hardening the films by drying. “L*C*h colorimetric system” refers to a chart in which L*a*b* colorimetric system which was specified by International Illumination Committee in 1976 and has been adopted also as JIS Z 8729 is indicated with polar coordinates, L* standing for value, C* standing for chroma expressed as a distance from the origin and h, standing for hue angle anti-clockwisely shifted from 0° at a* red directioned axis in L*a*b* colorimetric system, in correspondence to individual hue.

Such color clear paint (C) can be formulated by mixing and dispersing above-described components.

The color clear paint (C) can be applied by such means as electrostatic coating, air spray, airless spray and the like, to a film thickness preferably of 0.5-30 μm, in particular, 5-25 μm, in terms of hardened coating film. When spray coated, the solid content of the color clear paint (C) is preferably adjusted in advance to 15-50% by weight, in particular, 20-40% by weight, and its viscosity at 20° C., to 11-15 seconds/Ford cup # 4. The coating film per se of such color clear paint (C) can be hardened normally at temperatures from about 70° C. to about 150° C.

Top Clear Paint (D)

According to the method of the present invention, further a layer or two or more layers of top clear paint (D) can be applied onto the coating film obtained by applying the color clear paint (C) as above (color clear coat), to form top clear coat.

The top clear paint (D) used in the method of the present invention is a liquid or powder paint essentially containing a resin component composed of main resin and crosslinking agent and further additives for paint, solvent such as water or organic solvent where necessary, which forms colorless or colored transparent coating film. Said top clear paint can be applied onto unhardened or hardened coated surface with the color clear paint (C).

As the top clear paint (D), any per se known clear paints can be used without any limitation. For example, liquid or powder paint compositions containing a resin component composed of main resin and crosslinking agent as the vehicle can be used. As the main resin, for example, acrylic resin, polyester resin, alkyd resin, fluorocarbon resin, urethane resin, silicone-containing resin and the like which contain crosslinkable functional groups such as hydroxyl, carboxyl, silanol or epoxy groups can be named. As said crosslinking agent, compounds or resins having functional groups reactable with said functional groups in the main resin, for example, melamine resin, urea resin, polyisocyanate compound, blocked polyisocyanate compound, epoxy compound or resin, carboxyl-containing compound or resin, acid anhydride, alkoxysilyl-containing compound or resin and the like can be named. The ratio between the main resin and the crosslinking agent in said resin component is not particularly limited, while generally the crosslinking agent can be used within a range of 10-100 parts by weight, preferably 20-80 parts by weight, inter alia, 30-60 parts by weight, per 100 parts by weight of solid content of the main resin.

Also where necessary, such top clear paint (D) can suitably contain solvent such as water or organic solvent, and additives for paint such as hardening catalyst, defoaming agent, UV absorber, rheology-controlling agent, antisettling agent and the like.

In top clear paint (D), color pigment may suitably be blended, within a range not impairing transparency of the coating film. As such color pigment, those per se known for use in ink or paint can be blended either singly or in combination of two or more. The blending amount varies depending on the kind of used color pigment, while it can be normally used in an amount not more than 30 parts by weight, preferably within a range of 0.05-20 parts by weight, inter alia, 0.1-10 parts by weight, per 100 parts by weight of the resin component as vehicle in the top clear part (D).

The top clear paint (D) can be formulated by mixing and dispersing the above-described components.

The top clear paint (D) can be applied by such means as electrostatic coating, air spray, airless spray and the like, to a film thickness preferably of 15-50 μm, in particular, 25-40 μm, in terms of hardened coating film. When the top clear paint (D) is in liquid form and spray coated, the solid content of the top clear paint (D) is normally preferably adjusted in advance to 30-60% by weight, in particular, 40-50% by weight and its viscosity at 20° C, to 18-25 seconds/Ford cup # 4. The coating film per se of such top clear paint (D) (top clear coat) can be hardened normally at temperatures from about 70° C. to about 150° C.

Formulation of Multilayered Coating Film

Following the method of the present invention, multilayered coating film of high saturation and excelling in deepness feel can be obtained by 4C2B steps, repeating 2C1B steps twice, said method comprising applying onto a substrate a base paint (A) and a clear paint (B) by the order stated, hardening these two paints by heating, thereafter applying a color clear paint (C) and a top clear paint (D) and hardening these two paints by heating.

It is desirable that thus formed multilayered coating film has a brightness such that the difference (ΔL) in value L* in L*C*h colorimetric system between the coating film obtained by applying said base paint (A) and the multilayered coating film is within 6, in particular, within 5, inter alia, within 4. Again the multilayered coating film preferably has a saturation such that the difference (ΔC) in chroma C* in L*C*h colorimetric system between the coating film obtained by applying said base paint (A) and the multilayered coating film is within a range of 1-20, in particular, 2-15, inter alia, 3-10. Here “value L*” and “chroma C*” can be determined through colorimetry, with SM Color Computer™ (a colorimeter manufactured by Suga Tester Co.), of object coating film of base paint (A) and the multilayered coating film which are obtained by applying the base paint (A) and the paints (A)-(D) on smooth art paper and hardening them by drying.

Adjustment of said difference in value (ΔL) and that in chroma (ΔC) between the coating film of base paitn (A) and the formed multilayered coating film; and adjustment of the difference in hue angle (Δh) between the coating film of base paint (A) and that of color clear paint (C) can be readily done by adjusting the kind and blended amount of those pigments contained in each of paints (A)-(D) used for forming the multilayered coating film, through small scale experiments.

Thus, the method of the present invention can be advantageously worked for forming multilayered coating film on various industrial articles, in particular, outer panels of car bodies.

Hereinafter the invention is more specifically explained, referring to working examples.

### EXAMPLES

### Examples 1-4

(1) Preparation of Substrate

Onto a degreased and zinc phosphated steel sheet (JISG3141; size, 400 mm×300 mm×0.8 mm) a cationic electrostatic paint, “E1ECRON 9400 HB™ (Kansai Paint Co., epoxy resin polyamine-type cationic resin incorporated with a blocked polyisocyanate compound as hardening agent) was electrocoated to a film thickness of 20 μm in terms of hardened coating film, followed by 20 minutes' heating at 170° C. to effect crosslinkage and hardening to form an electrocoated film.

On so obtained electrocoated surface of the steel sheet, an intermediate paint LUGA-BAKE™ intermediate paint gray color (Kansai Paint Co., polyester resin/melamine resin type, organic solvent-based paint) was air spray coated to a film thickness of 30 μm in terms of hardened coating film, and hardened by crosslinkage by heating at 140° C. for 30 minutes, to form an intermediate coating film. Thus formed intermediate coated sheet was used as the substrate.

(2) Preparation of Paint Formulations

Per 80 wt parts (solid content) of a hydroxyl-containing acrylic resin^{note 1)} and 20 wt parts of melamine resin^{note 2)}, specified effect pigment and color pigment for base paint or color pigment for color clear paint were blended at the ratios indicated in Table 1, mixed by stirring and diluted to a viscosity suitable for coating to provide organic solvent-based paints each having a solid content of about 25%, which were used as base paint Nos. 1-4 in Examples 1-4.
note 1) hydroxyl-containing acrylic resin:

an acrylic resin solution which was obtained through copolymerization of methyl methacrylate 45%, n-butyl acrylate 12%, lauryl methacrylate 22% and 2-hydroxyethyl acrylate 21%, using as polymerization initiator t-butyl-peroxy-2-ethyl hexanoate, in xylol: heating residue 50%, hydroxyl value 100, number average molecular weight 20,000 and solution viscosity Y+/Gardner, 25° C.
note 2) melamine resin:

U-ban 20 SE™ (methyl butyl mixed etherified melamine resin, Mitsui Chemical)

TABLE 1

| | Base Paint | | | | Color | | |
|---|---|---|---|---|---|---|---|
| | flaky effect | | color | | Clear Paint | | Difference |
| | pigment | | pigment | | color pigment | | in Hue |
| No. | Kind | amount | kind | amount | kind | amount | Angle (Δh) |
| 1 | A/D | 0.1/7.5 | b/c/e | 11/2/0.1 | b/c | 0.7/0.3 | 12° |
| 2 | A/D | 0.1/7.5 | b/c/e | 11/2/0.1 | c/f | 0.4/0.4 | 26° |
| 3 | A/B | 1.5/7.5 | a | 7.5 | a | 0.3 | 11° |
| 4 | C/D | 7.2/1.5 | b/d/e | 8/3/0.1 | b/c | 0.2/0.4 | 23° |

Flaky Effect Pigment

A: aluminium flake pigment

(ALUPASTE™ 5207N, Toyo Aluminium)

B: Colored aluminium flake pigment blue

(FRIEND COLOR™ D600BL, Showa Alumi Powder Co.)

C: Colored aluminium flake pigment orange

(PALIOCROM ORANGE™ L2800, BASF AG)

D: Colored mice pigment red

(E. M. SUPER RUSSET™, Engelhard Corp.)

Color Pigment

a: Phthalocyanine Blue pigment

(CYANINE BLUE™ PK-110, Dainichi Seika Co.)

b: Anthraquinone Red pigment

(CROMOPHTAL RED™ A2B, Ciba Specialties, Inc.)

c: Perylene Red pigment

(PERRIND MAROON™ 179 R6424, Sun Chemical)

d: Quinacridone Red pigment

(CINQUASIA MAGENTA™ B RT-343D, Ciba Specialties, Inc.)

e: Carbon Black pigment

(BLACK PEARLS™ 1300, Cabot-Corp)

f;: Isoindolinone pigment

(IRGAZIN YELLOW™ 3RLT-N, Ciba Specialties, Inc.)

Difference in Hue Angle

Each of hue angle h in L*C*h colorimetric system of coating films obtained by applying those base paints and those obtained by applying color clear paints was measured by the method as earlier described and the difference (absolute value) therebetween was calculated.

(3) Preparation of Test Sample Sheets

Through the following procedures, each of the base paints as prepared in (2) above, a commercial clear paint, color clear paints as prepared in (2) above and a commercial top clear paint were applied by the order stated, to provide test sample sheets.

(Application of Base Paint)

Onto the intermediate coated sheet as prepared in (1) above, each of the base paint Nos. 1-4 as prepared in (2) above was applied with a minibell rotatory electrostatic coater, under the conditions of the booth temperature 20° C. and humidity 75%, to a film thickness of about 15 μm in terms of hardened coating film.

(Application of Clear Paint)

The base paint-coated sheets were left to stand at room temperature for 15 minutes, and then onto their unhardened coated surface a clear paint (LUGA-BAKE Clear™, Kansai Paint, acrylic resin•amino resin type, an organic solvent-based paint) was applied with a minibell rotatory electrostatic coater, under the conditions of the booth temperature 20° C. and humidity 75%, to a film thickness of about 30 μm in terms of hardened coating film. After the application the sheets were allowed to stand at room temperature for 15 minutes, and heated in a hot air-circulation type drying oven at 140° C. for 30 minutes to harden the base coat and clear coat and to form multilayered coating films.

(Application of Color Clear Paints)

Onto so obtained multilayered coating films, each of the color clear paint Nos. 1-4 as prepared in (2) above was applied with REA gun under the conditions of the booth temperature 20° C. and humidity 75%, to a film thickness of about 15 μm in terms of hardened coating film.

(Application of Top Clear Paint)

The color clear paint-coated sheets were allowed to stand at room temperature for 15 minutes, and then onto their unhardened coated surface a top clear paint (LUGA-BAKE Clear™, Kansai Paint, acrylic resin•amino resin type, an organic solvent-based paint) was applied with a minibell rotatory electrostatic coater, under the conditions of the booth temperature 20° C. and humidity 75%, to a film thickness of about 30 μm in terms of hardened coating film. After the application the sheets were allowed to stand at room temperature for 15 minutes, and heated in a hot air-circulation type drying oven at 140° C. for 30 minutes to harden the multilayered film formed of the color clear coat and top clear coat simultaneously, to provide test sample sheets.

In thus formed multilayered coating films, the difference in value L* (ΔL) and that in chroma C* (ΔC) in L*C*h colorimetric system between the coating films of the base paints and the multilayered coating films were as follows.

| Example | Difference in | Difference in |
|---|---|---|
| No. | Value (ΔL) | Chroma (ΔC) |
| 1 | 2.5 | 3.8 |
| 2 | 2.3 | 4.8 |
| 3 | 3.1 | 4.1 |
| 4 | 2.8 | 4.5 |

### Examples 5-8

(1) Preparation of Substrate

Degreased and zine phosphated steel sheet similar to that used in Examples 1-4 was coated with an electrostatic paint, and onto the resulting electrostatic coating film further an intermediate paint was applied, whereby obtained intermediate paint-coated sheet was used as the substrate.

(2) Preparation of Paint Formulations

Per 80 wt parts (solid content) of the hydroxyl-containing acrylic resin^{note 1)} and 20 wt parts of the melamine resin^{note 2)}, effect pigments and color pigments for base paint as identified in Table 1 were blended at the ratios shown under Nos. 1-4 of said Table 1, mixed by agitation and diluted to a viscosity suitable for coating to provide organic solvent-based paints each having a solid content of about 25%, which were used as base paint Nos. 5-8 in Examples 5-8, respectively.

Also those color pigments for color clear paints as shown in Table 1 were blended with commercial top clear paint (LUGA-BAKE Clear™, Kansai Paint, acrylic resin amino resin type, an organic solvent-based paint) each at the ratio indicated under Nos. 1-4 of same Table 1, mixed by agitation and diluted to a viscosity suitable for coating to provide organic solvent-based paints each having a solid content of about 25%, which were used as color clear paint Nos. 5-8 in Examples 5-8, respectively.

(3) Preparation of Test Sample Sheets

Through the following procedures, each of the base paints as prepared in (2) above, a commercial clear paint, color clear paints as prepared in (2) above and a commercial top clear paint were applied by the order stated, to provide test sample sheets.

(Application of Base Paints)

Onto the intermediate coated sheet as prepared in (1) above, each of the base paint Nos. 5-8 as prepared in (2) above was applied with a minibell rotatory electrostatic coater, under the conditions of the booth temperature 20° C. and humidity 75%, to a film thickness of about 15 μm in terms of hardened coating film.

(Application of Clear Paint)

The base paint-coated sheets were left to stand at room temperature for 15 minutes, and then onto their unhardened coated surface a clear paint (LUGA-BAKE Clear™, Kansai Paint, acrylic resin•amino resin type, an organic solvent-based paint) was applied with a minibell rotatory electrostatic coater, under the conditions of the booth temperature 20° C. and humidity 75%, to a film thickness of about 30 μm in terms of hardened coating film. After the application the sheets were allowed to stand at room temperature for 15 minutes, and heated in a hot air-circulation type drying oven at 140° C. for 30 minutes to harden the base coat and clear coat and to form multilayered coating films.

(Application of Color Clear Paints)

Onto so obtained multilayered coating films, each of the color clear paint Nos. 5-8 prepared in (2) above was applied with a minibell rotatory electrostatic coater under the conditions of the booth temperature 20° C. and humidity 75%, to a film thickness of about 30 μm in terms of hardened coating film.

(Application of Top Clear Paint)

The color clear paint-coated sheets were allowed to stand at room temperature for 15 minutes, and then onto their unhardened coated surface a top clear paint (LUGA-BAKE Clear™, Kansai Paint, acrylic resin•amino resin type, an organic solvent-based paint) was applied with a minibell rotatory electrostatic coater, under the conditions of the booth temperature 20° C. and humidity 75%, to a film thickness of about 30 μm in terms of hardened coating film. After the application the sheets were allowed to stand at room temperature for 15 minutes, and heated in a hot air-circulation type drying oven at 140° C. for 30 minutes to harden the multilayered film formed of the color clear coat and top clear coat simultaneously, to provide test sample sheets.

In thus formed multilayered coating films, the difference in value L* (ΔL) and that in chroma C* (ΔC) in L*C*h colorimetric system between the coating films of the base paints and the multilayered coating films were as follows.

| Example | Difference in | Difference in |
|---|---|---|
| No. | Value (ΔL) | Chroma (ΔC) |
| 5 | 2.4 | 4.1 |
| 6 | 2.3 | 5.0 |
| 7 | 3.3 | 4.3 |
| 8 | 3.1 | 4.2 |

### Comparative Examples 1-3

(1) Preparation of Substrate

Degreased and zine phosphated steel sheet similar to that used in Examples was coated with an electrostatic paint, and onto the resulting electrostatic coating film further an intermediate paint was applied, whereby obtained intermediate paint-coated sheet was used as the substrate.

(2) Preparation of Paint Formulations

Per 80 wt parts (solid content) of the hydroxyl-containing acrylic resin^{note 1)} and 20 wt parts of the melamine resin^{note 2)}, effect pigments and color pigments for base paint were blended at the ratios shown in Table 2, mixed by agitation and diluted to a viscosity suitable for coating to provide organic solvent-based paints each having a solid content of about 25%, which were used as base paint Nos. 1-3 in Comparative Examples 1-3, respectively.

Also those color pigments for color clear paints were blended with the commercial top clear paint (LUGA-BAKE Clear™, Kansai Paint, acrylic resin amino resin type, an organic solvent-based paint) each at the ratio as indicated in Table 2, mixed by agitation and diluted to a viscosity suitable for coating to provide organic solvent-based paints each having a solid content of about 25%, which were used as color clear paint Nos. 1-3 in Comparative Examples 1-3, respectively.

TABLE 2

| | Base Paint | | | | Color Clear | | |
|---|---|---|---|---|---|---|---|
| | Flaky | | color | | Paint | | Difference |
| | effect pigment | | pigment | | color pigment | | in Hue |
| No. | Kind | amount | kind | Amount | kind | amount | Angle (Δh) |
| 1 | A/D | 0.15/11.3 | b/c/e | 16.5/3/0.15 | b/c | 1.1/0.45 | 27° |
| 2 | A/D | 0.15/11.3 | b/c/e | 16.5/3/0.15 | c/f | 0.6/0.6 | 35° |
| 3 | A/B | 2.3/11.3 | a | 11.3 | a | 0.45 | 21° |

Effect pigment A-D and color pigments a-f in Table 2 signify the same to those in Table 1, and the differences in hue angle (Δh) were determined in the same manner as explained as to Table 1.

(3) Preparation of Test Sample Sheets

Through the following procedures, each of the base paints as prepared in (2) above, color clear paints as prepared in (2) above and a commercial top clear paint were applied by the order stated, to provide test sample sheets.

(Application of Base Paints)

Onto the intermediate coated sheet as prepared in (1) above, each of the base paint Nos. 1-3 as prepared in (2) above was applied with a minibell rotatory electrostatic coater, under the conditions of the booth temperature 20° C. and humidity 75%, to a film thickness of about 15 μm in terms of hardened coating film.

(Application of Color Clear Paint)

The base paint-coated sheets were left to stand at room temperature for 15 minutes, and then onto their unhardened coated surface each of the color clear paint Nos. 1-3 as prepared in (2) above was applied with a minibell type rotatory electrostatic coater under the conditions of the booth temperature 20° C. and humidity 75%, to a film thickness of about 11 μm in terms of hardened coating film.

(Application of Top Clear Paint)

The color clear paint-coated sheets were allowed to stand at room temperature for 15 minutes, and then onto their unhardened coated surface a top clear paint (LUGA-BAKE Clear™, Kansai Paint, acrylic resin amino resin type, an organic solvent-based paint) was applied with a minibell rotatory electrostatic coater, under the conditions of the booth temperature 20° C. and humidity 75%, to a film thickness of about 30 μm in terms of hardened coating film. After the application the sheets were allowed to stand at room temperature for 15 minutes, and heated in a hot air-circulation type drying oven at 140° C. for 30 minutes to dry and harden the multilayered coating film formed of the base coat, color clear coat and top clear coat simultaneously, to provide the test sample sheets.

In thus formed multilayered coating films, the difference in value L* (ΔL) and that in chroma C* (ΔC) in L*C*h colorimetric system between the coating films of the base paints and the multilayered coating films were as follows.

| Comparative | Difference in | Difference in |
|---|---|---|
| Example No. | Value (ΔL) | Chroma (ΔC) |
| 1 | 3.5 | 2.5 |
| 2 | 2.8 | 3.1 |
| 3 | 4.5 | 3.8 |

Evaluation Test

Those test sample sheets which were obtained in the foregoing Examples and Comparative Examples were visually evaluated in respect of deepness feel and the extent of occurrence of framing. The results were as shown in Table 3.

TABLE 3

| | No. | Deepness Feel | Framing |
|---|---|---|---|
| Example | 1 | 4 | 4 |
| | 2 | 4 | 4 |
| | 3 | 4 | 4 |
| | 4 | 4 | 4 |
| | 5 | 4 | 3 |
| | 6 | 4 | 3 |
| | 7 | 4 | 3 |
| | 8 | 4 | 3 |
| Comparative | 1 | 1 | 2 |
| Example | 2 | 2 | 1 |
| | 3 | 2 | 2 |

Deepness Feel
4: excellent deepness feel
3: deepness feel recognizable
2: deepness feel slightly recognizable
1: no deepness feel recognizable

Framing
4: no framing occurred
3: framing occurred slightly
2: framing occurred
1: framing occurred markedly.

1. A method for forming multilayered coating film characterized by comprising applying onto a substrate base paint (A) containing effect pigment, applying onto the resulting base coat, clear paint (B), thereafter hardening the coating film by heating, further applying onto the resulting clear coat, color clear paint (C) containing color pigment and/or dye, and applying onto the resulting color clear coat, top clear paint (D).

2. The method according to claim 1, in which said effect pigment is selected from the group consisting of flaky metallic pigment, flaky metallic pigment with metal oxide-covered surface, flaky metallic pigment onto whose surface color pigment is chemically adsorbed, and metal oxide-covered colored mica pigment.

3. The method according to claim 1, in which said base paint (A) contains 1-50 parts by weight of effect pigment per 100 parts by weight of the resin component serving as the vehicle.

4. The method according to claim 1, in which the coated film thickness of said base paint (A) lies within a range of 0.5-30 μm in terms of the hardened coating film.

5. The method according to claim 1, in which the coated film thickness of said clear paint (B) lies within a range of 15-50 μm in terms of the hardened coating film.

6. The method according to claim 1, in which said color clear paint (C) contains 0.01-20 parts by weight of color pigment or 0.01-20 parts by weight of color pigment or 0.01-10 parts by weight of dye, per 100 parts by weight of the resin component serving as the vehicle.

7. The method according to claim 1, in which at least a part of the resin component of said color clear paint (C) is same to that of said base paint (A).

8. The method according to claim 1, in which the difference (Δh) in hue angle h referring to L*C*h colorimetric system between the coating film obtained by applying said base paint (A) and the coating film obtained by applying said color clear paint (C) is not more than 50°.

9. The method according to claim 8, in which the difference (Δh) in hue angle h referring to L*C*h colorimetric system between the coating film obtained by applying said base paint (A) and the coating film obtained by applying said color clear paint (C) is not more than 40°.

10. The method according to claim 1, in which said base paint (A) further contains color pigment, and at least one of the color pigments contained in said color clear paint (C) has the same chemical structure to that of the color pigment contained in the base paint (A).

11. The method according to claim 1, in which the coated film thickness of said color clear paint (C) lies within a range of 0.5-30 μm in terms of the hardened coating film.

12. The method according to claim 1, in which the coated film thickness of said top clear paint (D) lies within a range of 15-50 μm in terms of the hardened coating film.

13. The method according to claim 1, in which the difference (ΔL) in value L* referring to L*C*h colorimetric system between the coating film obtained by applying said base paint (A) and the formed multilayered coating film is not more than 6.

14. The method according to claim 13 in which the difference (ΔL) in value L* referring to L*C*h colorimetric system between the coating film obtained by applying said base paint (A) and the formed multilayered coating film is not more than 5.

15. The method according to claim 1, in which the difference (ΔC) in chroma C* referring to L*C*h colorimetric system between the coating film obtained by applying said base paint (A) and the formed multilayered film lies within a range of 1-20.

16. The method according to claim 15, in which the difference (ΔC) in chroma C* referring to L*C*h colorimetric system between the coating film obtained by applying said base paint (A) and the formed multilayered coating lies within a range of 2-15.

17. The method according to claim 1, which comprises applying onto a substrate base paint (A) and clear paint (B) by the order stated, hardening these two paints by heating, further applying color clear paint (C) and top clear paint (D), and hardening these two paints by heating.

18. Articles coated by the method as described in claim 1.

19. Articles of claim 18, which are car bodies.
